(19) United States
(12) Patent Application Publication
(10) Pub. No.: US 2013/0342469 A1
(43) Pub. Date: Dec. 26, 2013

(54) TOUCH INTENSITY BASED ON ACCELEROMETER READINGS

(71) Applicant: Richard A. Keeney, Prior Lake, MN (US)

(72) Inventor: Richard A. Keeney, Prior Lake, MN (US)

(73) Assignee: Microsoft Corporation, Redmond, WA (US)

(21) Appl. No.: 13/528,836

(22) Filed: Jun. 21, 2012

(51) Int. Cl. G06F 3/041

(52) U.S. Cl. 345/173

(57) ABSTRACT

A mobile device having a touch screen and an accelerometer may utilize the accelerometer readings to determine the intensity of a touch made to the touch screen. The force of the touch causes the mobile device to move and vibrate thereby causing a change in the acceleration forces along the axes of the mobile device. The accelerometer readings resulting from the touch may then be used to quantify the intensity of the touch. The touch intensity may then be used by interactive software applications to stimulate a reaction to the intensity of the user's touch.

### BACKGROUND

A touch screen is an input device that is commonly used in various electronic devices, such as mobile computing devices, cell phones, personal digital assistants (PDA), tablet computers, consumer appliances, and so forth. A touch screen is typically embedded within a display panel that is used to display images. A user interacts with the electronic device by touching the display panel with the user's finger or a pointing device and the position of the touch is detected by the touch screen. The touch screen has a sensing unit that detects the position of the touch. More recently, touch screens have been developed with sensing units that can detect the touch pressure in addition to the position of the touch. However, the cost and complexity of the pressure sensing units may be an impediment for such sensing units to be used in certain electronic devices and in legacy devices not utilizing such pressure sensing units.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A mobile device having a touch screen and an accelerometer may utilize the accelerometer readings to determine the intensity or impact of a touch to the touch screen. The force of the touch causes the mobile device to move and vibrate thereby causing a change in the acceleration forces along the axes of the mobile device. The accelerometer readings resulting from the movement and vibration may then be used to quantify the intensity of the touch. The touch intensity may then be used by interactive software applications to react to the force and intensity of the user's touch.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 illustrates an exemplary mobile device utilizing accelerometer readings to determine touch intensity.

FIG. 2 is a flow diagram illustrating an exemplary method of a touch intensity engine.

FIG. 3 is a block diagram illustrating an exemplary operating environment.

### DETAILED DESCRIPTION

Various embodiments pertain to a technology that derives a value indicating a measure of the intensity of a touch (or touch intensity) that is made to a touch screen utilizing accelerometer readings. The touch intensity is the force that may be applied by a user's finger or pointing device to a touch screen embedded within a mobile device. The force and impact of the touch causes the mobile device to move and vibrate thereby causing a change in the acceleration forces along the axes of the mobile device which can be measured by the accelerometer. The magnitude and/or frequency characteristics of the accelerometer readings may then be used to quantify the intensity of the touch.

The touch intensity may be used by other applications to react to the user's force. For example, an application may utilize the touch intensity to control the volume of the mobile device, to control the zoom ratio of an image displayed on the mobile device's display, to increase the jumping motion of a character in a video game or to increase the rate at which the pages of an e-book application are advanced. The touch intensity may be used in other applications as well.

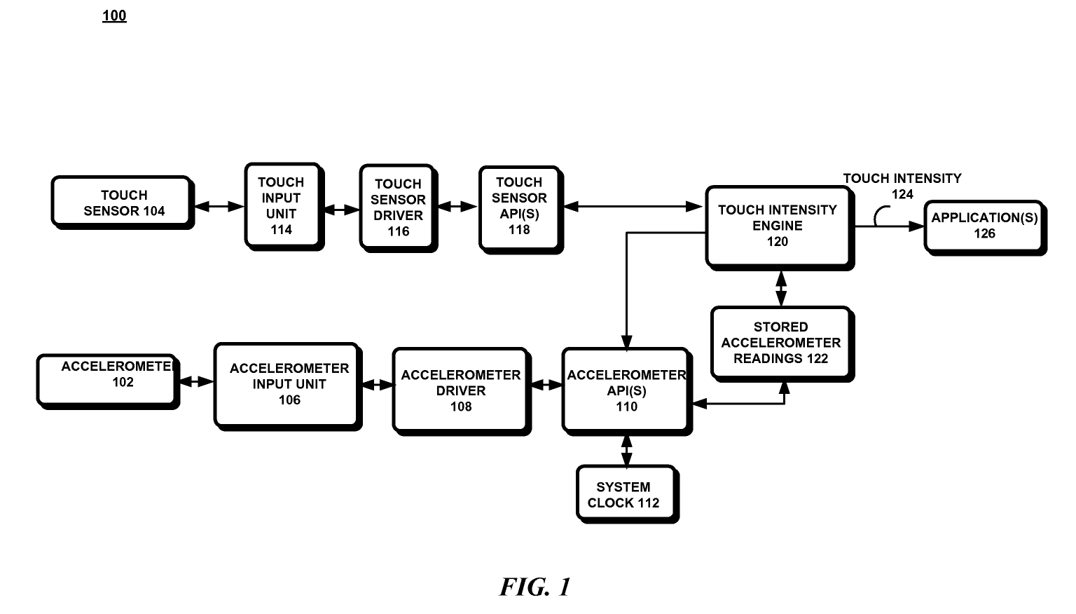

Attention now turns to a discussion of an exemplary mobile device. Turning to FIG. 1, there is shown a mobile device 100 having an accelerometer 102 and a touch sensor 104 that may both be embedded in the mobile device 100. The accelerometer 102 detects the amount of acceleration made by the mobile device resulting from movement of the mobile device at a particular point in time. The touch sensor 104 detects the presence of a touch onto a touch screen.

As accelerometers are also sensitive to gravitational forces, an accelerometer 102 is typically embedded in a mobile device 100 as a means to detect the relative direction of the earth's gravity so as to align the image on the display in the same direction as the mobile device 100. Images displayed on a mobile device 100 may be presented in portrait or landscape view. The mobile device 100 switches between portrait and landscape view based on the change in direction of the mobile device 100. The accelerometer 102 is used to detect the change in direction of the mobile device 100. Accelerometers 102 are also used to detect when the mobile device 100 may be free falling such as when dropped. In this case, the mobile device 100 may utilize the accelerometer 102 to detect the free fall and initiate safety precautions to mitigate any potential damage that may occur to the mobile device 100.

The accelerometer 102 measures the forces exerted on a mobile device 100 in one or more dimensions at a particular point in time. An accelerometer 102 may be configured to sense acceleration in one, two, or three dimensions or axes. In several embodiments, the accelerometer 102 may be configured to sense acceleration in the x, y, and z-axes associated with the mobile device 100. However, it should be noted that the embodiments are not constrained to any particular type of accelerometer or number of axes. The technology described herein may utilize accelerometer readings along a single axis, two or more axes, or any combination thereof.

The measurements or readings from the accelerometer 102 reflect the acceleration forces exerted onto the mobile device 100 attributable to the mobile device's movement. In one or more embodiments, the measurements may be expressed as a three-dimensional vector, where each value represents the acceleration force along a particular axis. In particular, the three values of the accelerometer vector represent an acceleration force along the x-axis, y-axis, and z-axis of the position of the mobile device 100 at a particular point in time. Each value from the accelerometer 102 may be expressed in units of m/s², where m represents meters and s represents seconds, or in units of g, where g represents one gravity and where 1 g=9.80665 m/s².

The accelerometer 102 may generate one or more signals indicative of the acceleration of the mobile device at a particular point in time. For example, the accelerometer 102 may generate a first signal indicating acceleration above a threshold and a second signal indicating a general acceleration. The embodiments are not limited in this manner.

Accelerometers 102 are typically implemented as a semiconductor device having input and output ports that are accessible through an interface. The input ports may be used to configure the accelerometer 102 in a prescribed manner and the output ports transmit signals indicative of the acceleration along the x-axis, y-axis, and z-axis. The accelerometer signals may be received by an accelerometer input unit 106.

The accelerometer input unit 106 may transmit the accelerometer signals to an accelerometer driver 108. The accelerometer driver 108 may be configured to perform some pre-processing on the signals. An accelerometer application programming interface (API) may read the accelerometer signals and send them as accelerometer readings directly to subscribing software applications or provide the accelerometer readings upon request. The accelerometer readings provided by the accelerometer API 110 are real time values without an associated time unit. The accelerometer API 110 may add a timestamp to the readings to associate a point in time with the readings. The accelerometer API 110 may make a call to the system clock 112 to obtain a time value for the timestamp. Thus, the accelerometer readings may include numeric values for the x-axis, y-axis, z-axis, and a timestamp.

The touch sensor 104 may be coupled to a touch input unit 114 that receives signals from the touch sensor 104. The touch input unit 114 may transmit the signals to a touch sensor driver 116 that may be configured to perform some pre-processing on the signals prior to transmitting the signals to a touch sensor API 118. The touch sensor API 118 may send the touch sensor data directly to subscribing software applications or provide the touch sensor data upon request.

The mobile device 100 may include a touch intensity engine 120 that calculates the touch intensity of a touch applied to the touch screen. The touch intensity engine 120 may continuously call the accelerometer API 110 and store the returned accelerometer readings 122. The touch intensity engine 120 may also receive notifications from the touch sensor API 118 when a touch is sensed. Based on the received data, the touch intensity engine 120 calculates a value representing the touch intensity 124 that may be output to one or more applications 126.

In one or more embodiments, the accelerometer API(s) 110, touch sensor API(s) 118, the accelerometer sensor driver 108 and the touch sensor driver 116 may be implemented in software. One or more of these components may be part of the mobile device's operating system. In one or more embodiments, the mobile device may utilize the Microsoft® Windows® Phone Operating system and the APIs 110, 118 may be part of the motion sensor APIs supported by the Microsoft® Windows® Phone Operating System. However, the technology described herein is not limited to this particular operating system or APIs.

The accelerometer API(s) 110, touch sensor API(s) 118, the accelerometer sensor driver 108, the touch sensor driver 116, and the touch intensity engine 120 may be a sequence of computer program instructions, that when executed by a processor, causes the processor to perform methods and/or operations in accordance with a prescribed task. The accelerometer API(s) 110, touch sensor API(s) 118, the accelerometer sensor driver 108, the touch sensor driver 116, and the touch intensity engine 120 may be implemented as program code, programs, procedures, module, code segments, program stacks, middleware, firmware, methods, routines, and so on. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Attention now turns to operations for the embodiments of the touch intensity engine 120 which may be further described with reference to various exemplary methods. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. The methods can be implemented using one or more hardware elements and/or software elements of the described embodiments or alternative embodiments as desired for a given set of design and performance constraints. For example, the methods may be implemented as logic (e.g., computer program instructions) for execution by a logic device (e.g., a general-purpose or specific-purpose computer).

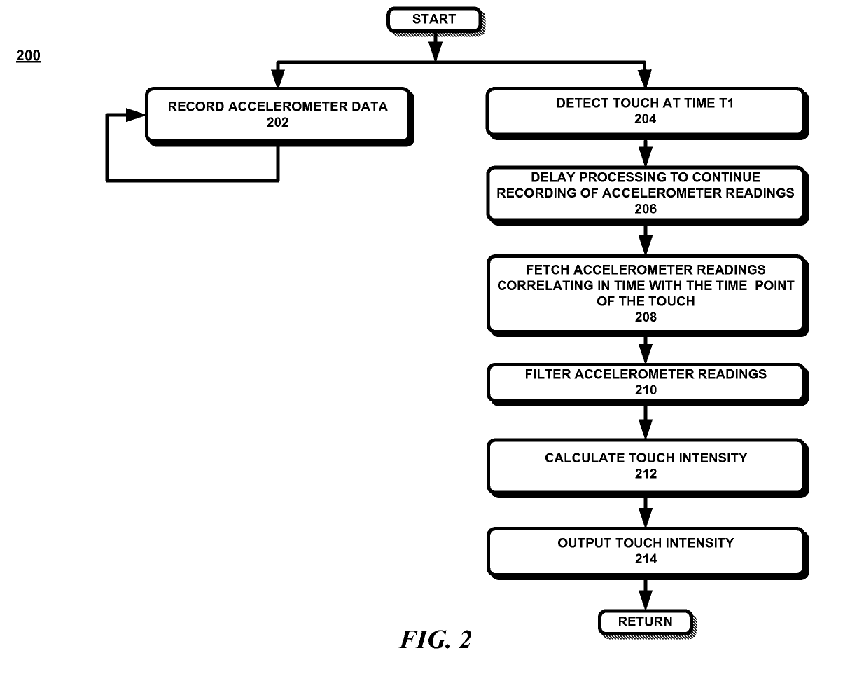

FIG. 2 is a flow diagram illustrating an exemplary method 200 of the touch intensity engine 120. It should be noted that the method may be representative of some or all of the operations executed by one or more embodiments described herein and that the method can include more or less operations than that which is described in FIG. 2.

The touch intensity engine 120 may be configured as a single process having multiple threads of execution. A process is an instance of an application that is configured with the resources needed to execute it. A thread is an independent execution unit that executes a subset of the touch intensity engine's instructions or code. As shown in FIG. 2, the touch intensity engine 120 may include one thread that continuously records accelerometer data (block 202). The touch intensity engine 120 may initiate a call to the accelerometer API 110 at periodic intervals continuously and store the accelerometer readings and a time stamp in a buffer. For example, in some cases, there may be 50 accelerometer readings, or acceleration vectors, generated per second. The number of acceleration vectors that may be generated and the frequency is dependent on the components of the mobile device, such as the type of accelerometer and the structure of the software components that interface with the accelerometer.

The touch intensity engine 120 may include a second thread that commences processing once a touch to the touch screen is detected at a particular point in time, T1 (block 204). The touch may be detected by the touch sensor and provided to the touch intensity engine 120 through the touch sensor API 118. A momentary delay may be executed so that the first thread may continue to record the accelerometer readings (block 206). In some cases, there may already be sufficient delay generated by the touch sensor 104, touch sensor driver 116, and touch sensor API 118 prior to the touch intensity engine 120 becoming aware of the touch such that the additional delay may not be necessary.

After the delay has lapsed, the touch intensity engine 120 fetches those accelerometer readings that are in close proximity to the point of time, T1, when the touch was detected (block 208). The touch intensity engine 120 correlates the time of the touch, T1, with the timestamp of the accelerometer readings and obtains those accelerometer readings that are within a predetermined time period around the point of time of the touch, T1. For example, the touch intensity engine 120 may obtain those readings that are a first threshold amount of time, T2 time units, before T1, the time of the touch, and a second threshold amount of time, T3 time units, after T1. The values for T2 and T3 may be customized for a particular implementation, either by user, manufacturer of the mobile device, or otherwise configured.

In an alternative embodiment when time stamps are not available, the relative timing of the touch detection to the accelerometer readings can be pre-characterized by external measurements, trial and error, or other means. Other alternative embodiments are possible using well-known means for synchronizing or timing execution threads such that the accelerometer readings are correlated to the time near when the touch event is detected.

The touch intensity engine 120 may then filter the accelerometer readings to obtain those deemed statistically relevant (block 210). For example, the first level of filtering may be to subtract out the average-valued accelerometer reading during the time period of interest so as ignore the effects of gravity and lower-frequency accelerations not correlated with a touch event. Alternatively, the touch intensity engine 120 may filter out some of the accelerometer readings utilizing a histogram such that only a first threshold percent of the highest positive values or highest-valued accelerometer readings are utilized and a second threshold percent of only the lowest negative values or lowest-valued accelerometer readings are utilized as well. The remaining values are may be ignored in the calculation of the touch intensity.

Alternatively, any number of other commonly-known signal processing and filtering techniques may be employed to filter and isolate the portion of the accelerometer signal that correlates with a touch impact event so as to measure its magnitude.

The touch intensity may then be calculated (block 212). In one or more embodiments, the touch intensity may be calculated using a root mean square (RMS) function. The RMS represents a magnitude of a set of values that may include negative values. Alternatively, the touch intensity may then be calculated by converting the readings into the frequency domain and examining the intensity of the higher vibration frequencies typical of a touch impact.

The touch intensity may be calculated as the sum of the result of filtering the x-axis values, the y-axis values, and the z-axis values (block 212). As the exact orientation of the acceleration and vibration produced by a touch may vary depending on the physical configuration of the device and the relative location of the touch, it is generally advantageous to capture acceleration and vibration information resulting from the touch in any and all directions. Also, because the touch force and vibration is typically highly correlated amongst the axis of acceleration, there are signal to noise advantages to utilizing as many axis (channels) of accelerometer data as are available so as to help mitigate sample-rate and quantization limitations of the accelerometers typically available. The value of the touch intensity may then be output as a single value derived from the filtered data from the multiple accelerometer axis (block 214).

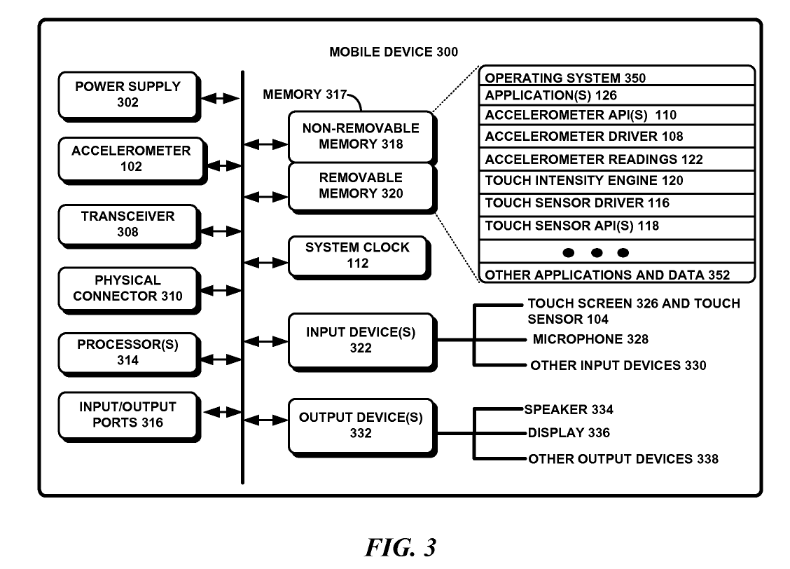

Attention now turns to a discussion of an exemplary operating environment. FIG. 3 illustrates an operating environment consisting of a mobile device 300 capable of implementing the technology described herein. It should be noted that the operating environment is exemplary and is not intended to suggest any limitation as to the functionality of the embodiments. Furthermore, although the mobile device 300 shown in FIG. 3 has a limited number of elements in a certain configuration, it should be appreciated that the mobile device 300 may include more or less elements in alternate configurations.

A mobile device 300 may be embodied as an electronic device such as, but not limited to, a mobile computing device (e.g., tablet, handheld computer, laptop, netbook, etc.), a cell phone, smart phone, a personal digital assistant, camera, video camera, or any other type of mobile computing device.

The mobile device 300 may include at least one processor 314 (e.g., signal processor, microprocessor, ASIC, or other control and processing logic circuitry) and a memory 317. In addition, the mobile device 300 may support one or more input devices 322 and output devices 332. The input devices 322 may include without limitation, a touch screen 326 including a touch sensor 104, a microphone 328, and any other type of input device 330 (e.g., camera, physical keyboard, trackball, etc.). The output devices 332 may include, without limitation, a speaker, a display, or any other type of output device 338. The touch screen 326 and display 336 may be combined into a single input/output device.

The mobile device 300 may further include one or more input/output ports 316, a power supply 302, an accelerometer 102, a transceiver 308 (for wirelessly transmitting analog or digital signals), and/or a physical connector 310, which may be a USB port, IEEE 1394 port, and/or RS-232 port.

The memory 317 may be any computer-readable storage media that may store executable procedures, applications, and data. The computer-readable media does not pertain to propagated signals, such as modulated data signals transmitted through a carrier wave. The memory 317 may include non-removable memory 318 and/or removable memory 320. The non-removable memory 318 may include RAM, ROM, flash memory, a hard disk or other well-known memory storage technologies. The removable memory 320 may include flash memory or a Subscriber Identity Module (SIM) card, or other memory storage technologies, such as “smart cards.” The memory 317 may contain instructions and data as follows:

an operating system 350;

one or more applications 126;

one or more accelerometer API(s) 110;

an accelerometer driver 108;

one or more accelerometer readings 122;

a touch intensity engine 120;

a touch sensor driver 116;

one or more touch sensor API(s) 118; and

other applications and data 352.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. For example, although the embodiments have been described with respect to the use of a touch sensor to detect the presence of a touch, other technologies and mechanism may be used to detect a touch Other suitable well-known technologies may include (without limitation) keyboards, keypads, buttons, switches, track-pads, touch-stylus, directional pad, joystick, knobs, dials, sliders, or electro-static sensitive contact areas.

Various embodiments may be implemented using hardware elements, software elements, or a combination of both. Examples of hardware elements may include devices, components, processors, microprocessors, circuits, circuit elements, integrated circuits, application specific integrated circuits, programmable logic devices, digital signal processors, field programmable gate arrays, memory units, logic gates and so forth. Examples of software elements may include software components, programs, applications, computer programs, application programs, system programs, machine programs, operating system software, middleware, firmware, software modules, routines, subroutines, functions, methods, procedures, software interfaces, application program interfaces, instruction sets, computing code, code segments, and any combination thereof. Determining whether an embodiment is implemented using hardware elements and/or software elements may vary in accordance with any number of factors, such as desired computational rate, power levels, bandwidth, computing time, load balance, memory resources, data bus speeds and other design or performance constraints, as desired for a given implementation.

What is claimed:

1. A processor-implemented method, comprising:
sensing a touch onto a mobile device at a first point in time;
obtaining a plurality of accelerometer readings correlated to a time period that coincides with the first point in time, the accelerometer readings including values representing acceleration along one or more axes of a mobile device housing the accelerometer; and
calculating an intensity of the touch based on a first subset of the accelerometer readings.

2. The processor-implemented method of claim 1, further comprising:
continuously recording accelerometer readings from an accelerometer embedded in the mobile device.

3. The processor-implemented method of claim 2, further comprising:
acquiring the first subset of the accelerometer readings, the first subset of accelerometer readings associated with a time stamp that immediately precedes the first point in time within a first threshold amount of time and immediately follows the first point in time by a second threshold amount of time.

4. The processor-implemented method of claim 3, further comprising:
prior to calculating the intensity of the touch, filtering the first subset of accelerometer readings to subtract the average-value of the accelerometer readings.

5. The processor-implemented method of claim 4, further comprising:
filtering out a first percent of highest-valued accelerometer readings and a second percent of lowest-valued accelerometer readings.

6. The processor-implemented method of claim 1, wherein each accelerometer reading includes a value for each of a x, y, and z axis associated with the mobile device.

7. The processor-implemented method of claim 1, wherein each accelerometer reading includes a value for at least two axes associated with the mobile device.

8. The processor-implemented method of claim 1, further comprising:
outputting the intensity of the touch to one or more interactive software applications.

9. A computer-readable storage medium storing thereon processor-executable instructions, comprising:
an accelerometer API, having instructions that when executed on a processor, returns an accelerometer vector having one or more values retrieved from an accelerometer, each value associated with an axis of a mobile device; and
a touch engine, having instructions that when executed on a processor, executes the accelerometer API to record the accelerometer vectors continuously, to obtain a set of accelerometer vectors that coincide with a time point that a touch is detected on the mobile device, and to calculate a touch intensity of the touch using the accelerometer vectors.

10. The computer-readable storage medium of claim 9, further comprising:
a touch sensor API, having instructions that when executed on a processor, returns data indicative of a touch made to a touch screen housed in the mobile device; and
the touch engine, having further instructions that when executed on a processor, utilizes the touch sensor API to detect the touch.

11. The computer-readable storage medium of claim 9, the touch engine further comprising instructions that when executed on a processor, calculates the touch intensity as a function of a root-mean-square computation of a subset of the accelerometer values.

12. The computer-readable storage medium of claim 11, the touch engine further comprising instructions that when executed on a processor, retrieves accelerometer vectors having a timestamp that precedes the time point by a first amount of time and a timestamp that succeeds the time point by a second amount of time.

13. The computer-readable storage medium of claim 12, the touch engine further comprising instructions that when executed on a processor, filters values of the accelerometer vectors to a subset based on an average value for each axis.

14. The computer-readable storage medium of claim 11, the accelerometer vector including a value for an x, y, and z axis associated with the touch screen.

15. A mobile device, comprising:
an accelerometer generating an acceleration vector at multiple time points;
a touch sensor configured to detect a touch applied to a touch screen at a first time point, the touch screen communicatively coupled to the mobile device; and
a processor, executing instructions that,
obtain a plurality of acceleration vectors from a time period including the first time point, and
calculates a touch intensity associated with the touch made at the first time point, the touch intensity based on the plurality of acceleration vectors.

16. The mobile device of claim 15, the processor further comprising instructions that obtains the plurality of acceleration vectors from recordings of accelerometer readings from a time period that precedes the first time point by a first threshold and succeeds the first time point by a second threshold.

17. The mobile device of claim 16, the processor further comprising instructions that filter the recordings of the accelerometer readings within the time range to ignore the mean value of the accelerometer readings.

18. The mobile device of claim 16, the accelerometer generating a value for at least two axes associated with the mobile device at a point in time.

19. The mobile device of claim 16, the accelerometer generating, at each point in time, a value for each of an x, y, and z axis associated with the mobile device.

20. The mobile device of claim 15, the processor further comprising instructions that calculates the touch intensity based on a root-mean-square calculation of the accelerometer readings.
